(19) United States
(12) Patent Application Publication
(10) Pub. No.: US 2006/0084398 A1
(43) Pub. Date: Apr. 20, 2006

(54) Method and apparatus for predictively optimizing efficiency of a radio frequency (RF) power amplifier

(76) Inventors: Maciej Chmiel, Temecula, CA (US); Erik Kerstenbeck, Ramona, CA (US)

Correspondence Address: DITTHAVONG & CARLSON, P.C., Suite A, 10507 Braddock Road, Fairfax, VA, 22032, US

(21) Appl. No.: 10/966,181

(22) Filed: Oct. 15, 2004

(51) Int. Cl. H04B 1/04

(52) U.S. Cl. 455/127.1; 455/115.1

(57) ABSTRACT

An approach provides for predictive and continuous supply voltage adjustment of a Radio Frequency (RF) power amplifier in a wireless terminal. A voltage value is predictively determined to continuously control a voltage converter of the wireless terminal for maximizing RF power amplifier efficiency. A control signal is output based on the determined voltage value, wherein, in response to the control signal, the voltage converter outputs a power amplifier supply voltage of the wireless terminal. The above arrangement has particular application to a cellular handset for improved battery life.

### FIELD OF THE INVENTION

The present invention relates to communications, and more particularly, to providing efficient transmission in a radio frequency (RF) system.

### BACKGROUND OF THE INVENTION

Radio communication systems, such as cellular systems, provide users with the convenience of mobility. This convenience has spawned significant adoption by consumers as an accepted mode of communication for business and personal uses. Cellular service providers, for example, have fueled this acceptance by developing more enhanced network services and applications. Consequently, manufacturers of mobile devices (e.g., cellular phones) are challenged to continually add greater and greater functional capabilities in smaller and smaller form factors. For instance, beyond the already advanced telephony and data capabilities, these devices can include other sophisticated functions and applications, such as digital camera functionality and gaming applications. The goals of greater functionalities with reduced form factor are at odds with the design of the power system of the mobile devices, in that generally more functions require more battery consumption. However, consumers expect more capability as well as identical, or even longer, operation of the phones, thereby providing longer talk-time, etc. Therefore, to be competitive, the manufacturers need to address the ever growing requirement for longer battery life.

Traditionally, advancements in battery life have concentrated on the battery manufacturers. Unfortunately, significant progress in battery technology requires breakthroughs in chemical and material science. These advancements in chemical and material science lag significantly behind the progress characteristic of the mobile communications industry. That is, the development cycle of battery technology cannot keep pace with the development cycle of mobile phone technology.

Therefore, there is a need for an approach to enhance transmission efficiency, which can yield improved battery life.

### SUMMARY OF THE INVENTION

These and other needs are addressed by the present invention, in which an approach is presented for continuously variable and predictive battery voltage adjustment to reach linearity limits for a given output power level on a Radio Frequency (RF) power amplifier (PA). The approach can be implemented in a transmitter (TX) automatic gain controller (AGC) of a wireless terminal (e.g., a cellular handset or phone, cordless phone, etc.); the TX AGC continuously controls a signal which varies the DC supply voltage applied to a TX RF power amplifier. According to one embodiment of the present invention, the continuously variable DC power amplifier supply voltage control is accomplished using a DC-DC converter. The output voltage of the DC-DC converter is controlled by the TX AGC of the wireless terminal. The DC voltage varies in amplitude to allow just enough power amplifier linearity to meet specifications at each power level. Effectively, the control voltage becomes an integral part of the TX AGC scheme and can be controlled through use of a digital-to-analog converter (DAC) in continuously variable fashion. The transfer function of the control voltage is predictive and can be stored in lookup tables, or dynamically derived from a high order equation. The wireless terminal, while processing a request from a base station to set the required RF output power, can retrieve the equation and recalculate the necessary control voltage for the DC-DC converter. The above arrangement advantageously extends battery life by maximizing the RF power amplifier's efficiency at a given RF output. This approach also can be readily deployed through software, thereby eliminating costly hardware modifications.

According to one aspect of an embodiment of the present invention, a method for adjusting a supply voltage of a power amplifier in a wireless terminal is disclosed. The method includes predictively determining a voltage value to continuously control a voltage converter of the wireless terminal. The method also includes outputting a control signal based on the determined voltage value, wherein, in response to the control signal, the voltage converter outputs to the power amplifier for minimizing the supply voltage of the power amplifier at a predetermined power level.

According to another aspect of an embodiment of the present invention, an apparatus includes a voltage converter configured to drive a supply of a power amplifier. Additionally, the apparatus includes logic configured to predictively determine a voltage value to continuously control the voltage converter for minimizing supply voltage of the power amplifier at a predetermined power level.

According to another aspect of an embodiment of the present invention, an apparatus includes a voltage converting means for driving a supply of a power amplifier. The apparatus also includes means for predictively determining a voltage value to continuously control the voltage converter for minimizing supply voltage of the power amplifier at a predetermined power level.

According to another aspect of an embodiment of the present invention, a method for extending talk time in a cellular handset is disclosed. The method includes predictively determining a variable supply voltage through a transmitter automatic gain control (AGC) logic of the cellular handset. The method also includes continuously applying the variable supply voltage to a transmitter power amplifier of the cellular handset for linear operation, wherein the variable supply voltage is set to minimize current drain on the transmitter power amplifier.

According to another aspect of an embodiment of the present invention, an apparatus for operating in a cellular system is disclosed. The apparatus includes a transmitter automatic gain control (AGC) logic configured to predictively determine a variable supply voltage of a transmitter power amplifier. Additionally, the apparatus includes a voltage converter configured to continuously apply the variable supply voltage to the transmitter power amplifier for linear operation, wherein the variable supply voltage is set to minimize current drain on the transmitter power amplifier.

According to another aspect of an embodiment of the present invention, a method for adjusting a supply voltage of a power amplifier in a wireless terminal is disclosed. The method includes receiving a control voltage from a processor configured to predictively output the control voltage for continuous control. The method also includes generating, in response to the control voltage, an output voltage to variably control the supply voltage of the power amplifier for minimizing current drain.

According to yet another aspect of an embodiment of the present invention, an apparatus for use in a cellular handset is disclosed. The apparatus includes means for receiving a control voltage from a processor configured to predictively output the control voltage for continuous control. The apparatus also includes means for generating, in response to the control voltage, an output voltage to variably control a supply voltage of a power amplifier for minimizing current drain.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a transmitter chain of a wireless terminal, according to an embodiment of the present invention;

FIG. 2 is a diagram of a cellular system capable of supporting the wireless terminal of FIG. 1;

FIG. 3 is a flowchart of a process for predictively determining a control voltage to minimize supply voltage of a Radio Frequency (RF) power amplifier in the wireless terminal of FIG. 1;

FIG. 4 is a graph of an exemplary supply voltage (Vcc) profile of a power amplifier used in the wireless terminal of FIG. 1;

FIG. 5 is a graph showing savings in power amplifier current, according to an embodiment of the present invention; and

FIG. 6 is a diagram of hardware that can be used to implement an embodiment of the present invention.

### DESCRIPTION OF THE PREFERRED EMBODIMENT

An apparatus, method, and software for predictively determining supply voltage adjustments for a power amplifier of a wireless terminal are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

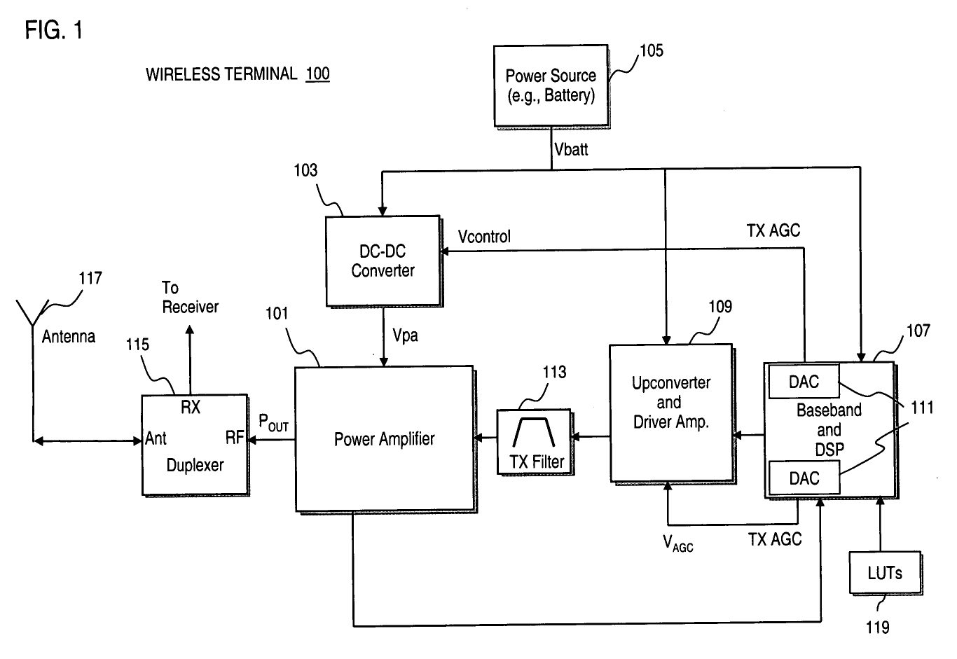

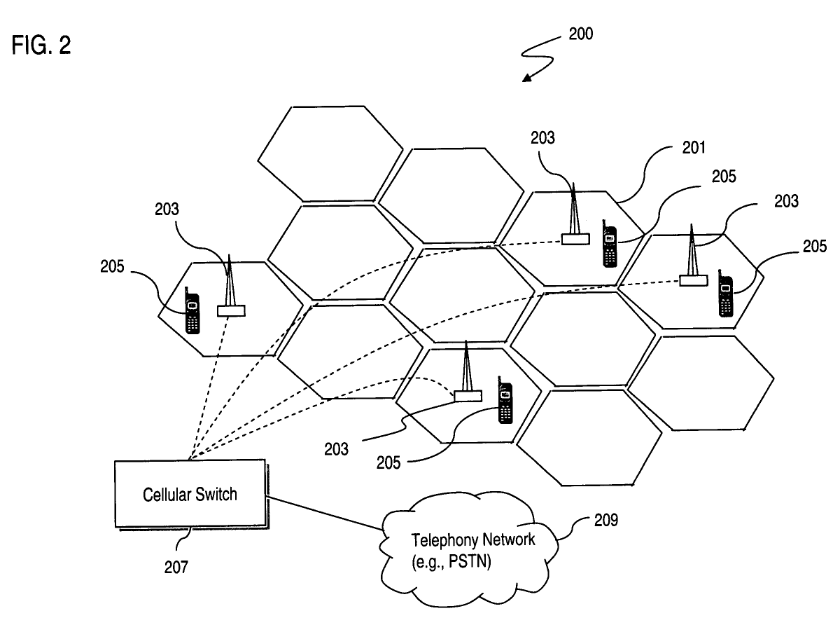

FIG. 1 is a diagram of a transmitter chain of a wireless terminal 100, according to an embodiment of the present invention. The wireless terminal 100 can operate in various radio communication systems, such as a cellular system of FIG. 2. By way of example, the wireless terminal 100 can be deployed as a cellular handset (or phone), a cordless phone, a mobile transmitter, a stationary wireless transmitter, a wireless personal digital assistant (PDA), a wireless modem, or a pager. The wireless terminal 100 employs an algorithmic approach to provide efficient transmission by minimizing a Radio Frequency (RF) power amplifier's power consumption. The approach can be implemented through a transmitter (TX) automated gain control (AGC) scheme that regulates power amplifier DC supply voltage by applying continuously predictive varying power amplifier supply voltage, as more fully described below. For the purposes of explanation, the present invention is described with respect to a cellular handset operating in a cellular network as shown in FIG. 2.

FIG. 2 is a diagram of a cellular system 200 capable of supporting the wireless terminal of FIG. 1. The cellular system 200 can be conceptually viewed as comprising cells 201 constituting a hexagonal frequency pattern. The cellular system 200 can be an analog system or a digital system, employing any number of standards and technologies, such as Code Division Multiple Access (CDMA), Time Division Multiple Access (TDMA), Global System for Mobile Communications (GSM), etc. Typically, one base station 203 defines one cell 201, which, in actual systems, varies in size depending on the terrain and capacity demands. The base stations 203 communicate with cellular phones 205 and process calls in conjunction with a cellular switch 207. The cellular switch 207 is responsible for handoffs between the base stations 203 as a cellular phone 205 crosses the cells. The cellular switch 207 also provides connectivity to other telephony networks 209, such as the Public Switched Telephone Network (PSTN).

Returning to the wireless terminal 100 of FIG. 1, a key component of the transmitter chain is an RF power amplifier 101, which is driven, for example, by a DC-DC converter 103. The DC-DC converter 103 accepts a DC (Direct Current) input voltage from a power source 105 and generates a DC output voltage in proportion to a control signal applied to it. In a cellular handset application, the power source 105 is a battery, which in an exemplary embodiment, utilizes Lithium-Ion technology and exhibits a capacity greater than 720 mAh. In this example, a baseband and Digital Signal Processor (DSP) block (or circuit) 107 produces a control voltage (V_{contol}) to control the DC-DC converter 103. Although the wireless terminal 100 is described with respect to a DC-DC converter 103, it is recognized that any component that is highly efficient (about 75% or greater conversion efficiency) in outputting a DC output voltage in response to an input control voltage can be utilized.

The baseband and DSP block 107 effects a transmitter AGC scheme in conjunction with an upconverter and driver amplifier circuit 109. The baseband and DSP block 107 includes digital-to-analog converters (DACs) 111. The upconverter and driver amplifier circuit 109 outputs a transmission signal that has been upconverted to a transmitter (TX) filter 113. The TX filter 113 shapes the upconverted signal to reduce noise and eliminate unwanted frequencies. The filtered signal is then amplified to the power amplifier 101. A duplexer 115 receives the amplified signal and radiates the energy over an antenna 117. The duplexer 115 allows simultaneous reception and transmission of RF signals over the antenna 117.

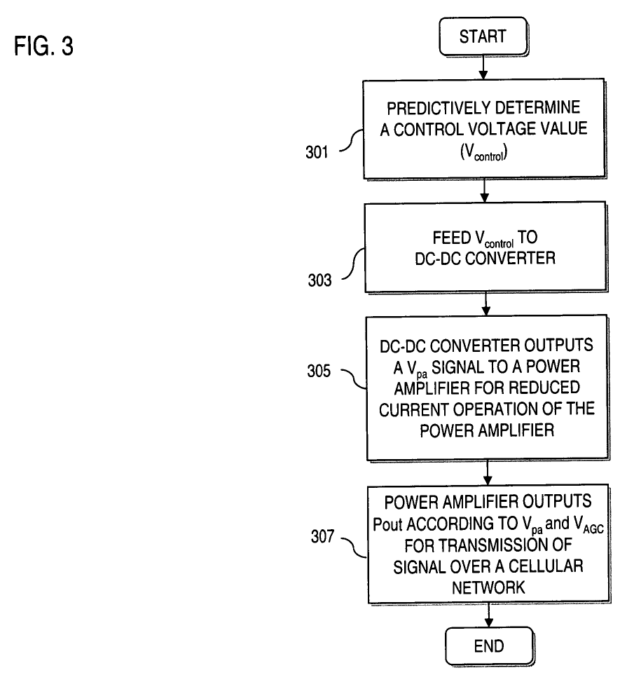

FIG. 3 is a flowchart of a process for predictively determining a control voltage to minimize supply voltage of an RF power amplifier in the wireless terminal of FIG. 1. In step 301, the baseband and DSP block 107 predictively determines a control voltage value (V_{control}) to minimize the supply voltage at a predetermined RF output power to meet linearity requirements. V_{control} is then fed to the DC-DC converter 103, per step 303. The DC-DC converter 103 has an analog output voltage control (Vₚₐ), which provides reduced current operation of the power amplifier 101 (step 305).

The output voltage of the DC-DC converter 103 is controlled by the TX AGC scheme. The DC voltage varies in amplitude to obtain sufficient power amplifier linearity to meet specifications at each RF output power level. By contrast, traditionally, a power amplifier is driven to generally have linearity margin over the specification, resulting in inefficient amplifier operation. The control voltage, which is algorithmically controlled by the DSP software, becomes an integral part of the TX AGC scheme and is continuously controlled through use of, for example, the DACs 111 of the baseband and DSP circuit 107.

The transfer function of the control voltage is predictive and stored in Look Up Tables (LUTs) 119, or dynamically derived from a high order equation. An exemplary equation (Nth order polynomial) is as follows:
V_{control}=Aₙ*[Pₒᵤₜ(dBm)]ⁿ+Aₙ₋₁*[Pₒᵤₜ(dBm)]ⁿ⁻¹+A₁*Pₒᵤₜ(dBm)+A,
wherein Aₙ, Aₙ₋₁, A₁ and A are coefficients of the polynomial. These coefficients may be stored in a memory (not shown) and can be adaptively learned by the varying V_{control} until a predetermined value is obtained. The wireless terminal 100, while processing a request to set the desired output power, can retrieve the equation (e.g., through the LUTs 119) and recalculate the necessary control voltage for the DC-DC converter 103.

In the step 307, the power amplifier 101 outputs Pₒᵤₜ, according to Vₚₐ supplied by the DC-DC converter 103 and V_{AGC} supplied to the upconverter block 109 for transmission of signals through the antenna 117.

The above process, when applied in a cellular handset for operation in the cellular network 200 of FIG. 2, advantageously minimizes power consumption by the power amplifier 101 while satisfying necessary amplifier linearity requirements, thereby improving talk time. Essentially, this process achieves improved power amplifier efficiency by converting linearity margins to current savings.

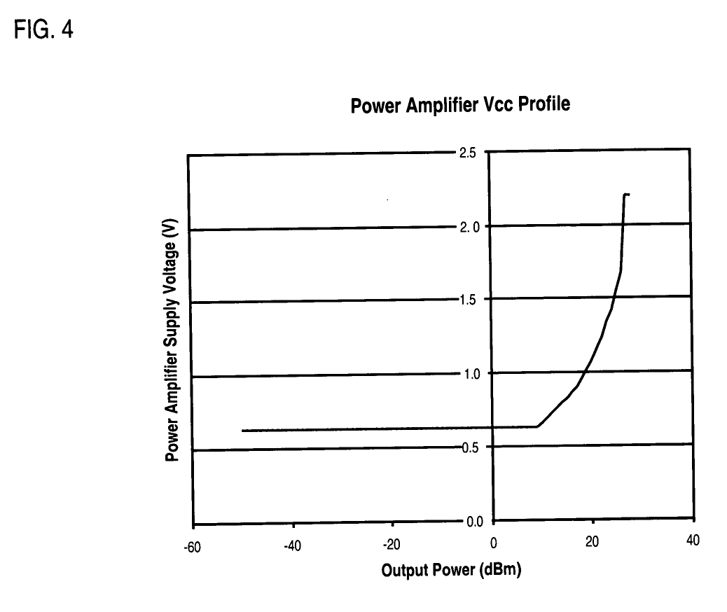

To better appreciate the achieved efficient power management, it is instructive to examine a supply voltage (Vcc) profile of the power amplifier 101, as shown in FIG. 4. This example illustrates a sample Vpa profile derived using the approach described in FIG. 3.

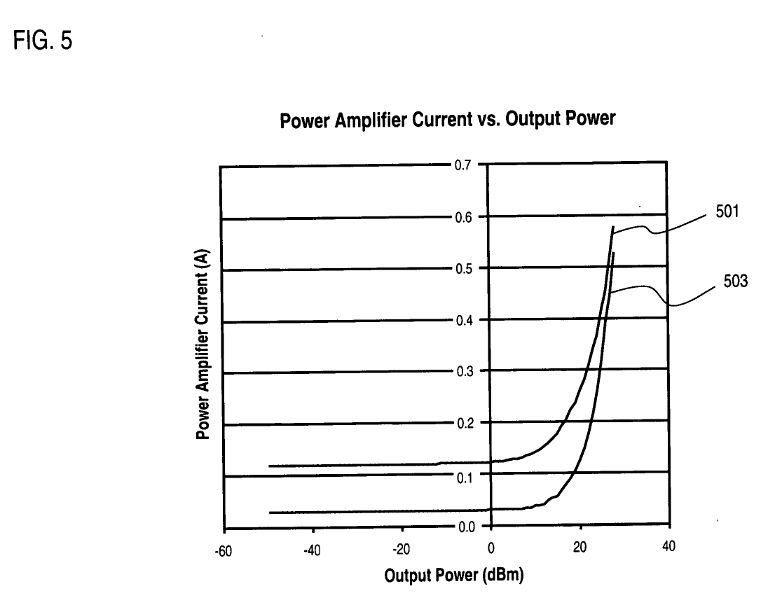

FIG. 5 is a graph showing savings in power amplifier current, according to an embodiment of the present invention. As seen, curve 501 represents the current drawn by the power amplifier 101 when there is no adjustment of the supply voltage. Curve 503 represents an adjusted supply voltage using the process of FIG. 3. The current savings are approximately 100 mA at a given power level, resulting in average current savings of 70 to 80%.

The predictive algorithm as detailed above can be executed through a variety of hardware and/or software configurations. In fact, this approach also can be readily deployed solely through a software change, thereby eliminating costly hardware modifications.

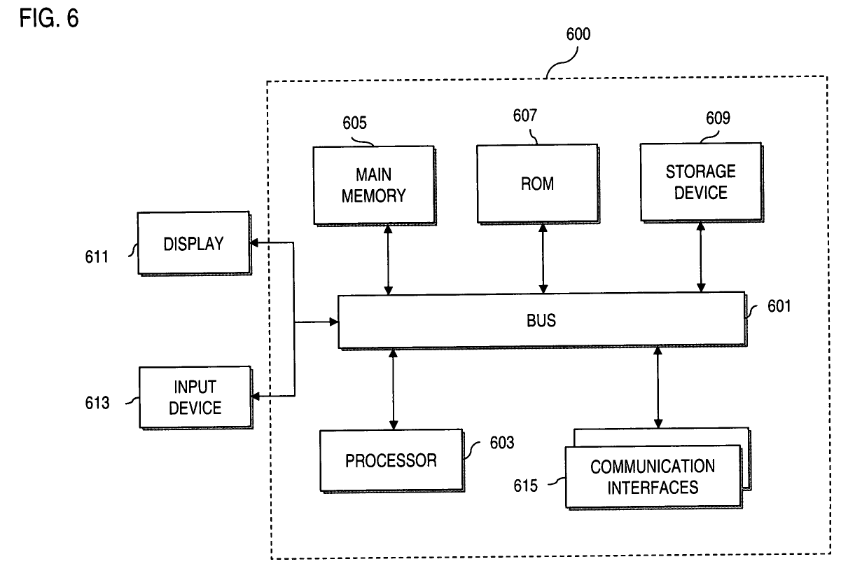

FIG. 6 illustrates exemplary hardware upon which an embodiment according to the present invention can be implemented. A computing system 600 includes a bus 601 or other communication mechanism for communicating information and a processor 603 coupled to the bus 601 for processing information. The computing system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computing system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computing system 600 may be coupled via the bus 601 to a display 611, such as a liquid crystal display, or active matrix display, for displaying information to a user. An input device 613, such as a keyboard including alphanumeric and other keys, may be coupled to the bus 601 for communicating information and command selections to the processor 603. The input device 613 can include a cursor control, such as a mouse, a trackball, or cursor direction keys, for communicating direction information and command selections to the processor 603 and for controlling cursor movement on the display 611.

According to one embodiment of the invention, the process of FIG. 3 can be provided by the computing system 600 in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the present invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the present invention are not limited to any specific combination of hardware circuitry and software.

The computing system 600 also includes at least one communication interface 615 coupled to bus 601. The communication interface 615 provides a two-way data communication coupling to a network link (not shown). The communication interface 615 sends and receives electrical, electromagnetic, or optical signals that carry digital data streams representing various types of information. Further, the communication interface 615 can include peripheral interface devices, such as a Universal Serial Bus (USB) interface, a PCMCIA (Personal Computer Memory Card International Association) interface, etc.

The processor 603 may execute the transmitted code while being received and/or store the code in the storage device 609, or other non-volatile storage for later execution. In this manner, the computing system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the present invention has been described in connection with a number of embodiments and implementations, the present invention is not so limited but covers various obvious modifications and equivalent arrangements, which fall within the purview of the appended claims.

What is claimed is:

1. A method for adjusting a supply voltage of a power amplifier in a wireless terminal, the method comprising:
predictively determining a voltage value to continuously control a voltage converter of the wireless terminal; and
outputting a control signal based on the determined voltage value,
wherein, in response to the control signal, the voltage converter outputs to the power amplifier for minimizing the supply voltage of the power amplifier at a predetermined power level.

2. A method according to claim 1, wherein the voltage converter is a DC-DC converter that receives an input voltage from a battery of the wireless terminal, and the determined voltage value minimizes current drain of the power amplifier.

3. A method according to claim 1, wherein the power amplifier is driven to a predetermined linearity requirement corresponding to the determined voltage value.

4. A method according to claim 1, wherein the determined voltage value is computed based on a transfer function that has values stored in a look-up table.

5. A method according to claim 1, wherein the determined voltage value is dynamically computed based on a transfer function.

6. A method according to claim 1, wherein the power amplifier outputs an amplified signal in response to the output from the voltage converter and an Automatic Gain Control (AGC) signal from an AGC logic.

7. A method according to claim 6, wherein the wireless terminal utilizes Code Division Multiple Access (CDMA) for communicating in a cellular system.

8. A method according to claim 1, wherein the wireless terminal is a cellular phone.

9. A computer-readable medium bearing instructions for adjusting a supply voltage of a power amplifier in a wireless terminal, said instructions, being arranged, upon execution, to cause one or more processors to perform the method of claim 1.

10. An apparatus comprising:
a voltage converter configured to drive a supply of a power amplifier; and
logic configured to predictively determine a voltage value to continuously control the voltage converter for minimizing supply voltage of the power amplifier at a predetermined power level.

11. An apparatus according to claim 10, further comprising:
a battery configured to power the voltage converter and the power amplifier,
wherein the voltage converter is a DC-DC converter that receives an input voltage from the battery, and the determined voltage value minimizes current drain of the power amplifier.

12. An apparatus according to claim 10, wherein the power amplifier is driven to a predetermined linearity requirement corresponding to the determined voltage value.

13. An apparatus according to claim 10, wherein the determined voltage value is computed based on a transfer function that has values stored in a look-up table.

14. An apparatus according to claim 10, wherein the determined voltage value is dynamically computed based on a transfer function.

15. An apparatus according to claim 10, wherein the logic includes a digital-to-analog converter (DAC) configured to generate a control signal representing the determined voltage value, the control signal being fed to the voltage converter.

16. An apparatus according to claim 15, wherein the power amplifier generates an output signal for transmission over a cellular system that utilizes Code Division Multiple Access (CDMA).

17. An apparatus comprising:
a voltage converting means for driving a supply of a power amplifier; and
means for predictively determining a voltage value to continuously control the voltage converter for minimizing supply voltage of the power amplifier at a predetermined power level.

18. An apparatus according to claim 17, further comprising:
a power source for powering the voltage converting means and the power amplifier,
wherein the voltage converting means is a DC-DC converter that receives an input voltage from the power source, and the determined voltage value minimizes current drain of the power amplifier.

19. An apparatus according to claim 17, wherein the power source is a battery.

20. An apparatus according to claim 17, wherein the power amplifier is driven to a predetermined linearity requirement corresponding to the determined voltage value.

21. An apparatus according to claim 17, wherein the determined voltage value is computed based on a transfer function that has values stored in a look-up table.

22. An apparatus according to claim 17, wherein the determined voltage value is dynamically computed based on a transfer function.

23. An apparatus according to claim 17, further comprising:
digital-to-analog converting means for generating a control signal representing the determined voltage value, the control signal being fed to the voltage converting means.

24. An apparatus according to claim 23, wherein the power amplifier generates an output signal for transmission over a cellular system that utilizes Code Division Multiple Access (CDMA).

25. A method for extending talk time in a cellular handset, the method comprising:
predictively determining a variable supply voltage through a transmitter automatic gain control (AGC) logic of the cellular handset; and
continuously applying the variable supply voltage to a transmitter power amplifier of the cellular handset for linear operation, wherein the variable supply voltage is set to minimize current drain on the transmitter power amplifier.

26. A method according to claim 25, wherein the transmitter power amplifier is powered by a battery of the cellular handset.

27. A method according to claim 26, wherein the cellular handset operates in a cellular system including a Code Division Multiple Access (CDMA) network, a Time Division Multiple Access (TDMA) network, or a Global System for Mobile Communications (GSM) network.

28. An apparatus for operating in a cellular system, the apparatus comprising:
a transmitter automatic gain control (AGC) logic configured to predictively determine a variable supply voltage of a transmitter power amplifier; and
a voltage converter configured to continuously apply the variable supply voltage to the transmitter power amplifier for linear operation, wherein the variable supply voltage is set to minimize current drain on the transmitter power amplifier.

29. An apparatus according to claim 28, further comprising:
a battery coupled to the voltage converter.

30. An apparatus according to claim 29, wherein the cellular system includes a Code Division Multiple Access (CDMA) network, a Time Division Multiple Access (TDMA) network, or a Global System for Mobile Communications (GSM) network.

31. A method for adjusting a supply voltage of a power amplifier in a wireless terminal, the method comprising:
receiving a control voltage from a processor configured to predictively output the control voltage for continuous control; and
generating, in response to the control voltage, an output voltage to variably control the supply voltage of the power amplifier for minimizing current drain.

32. A method according to claim 31, wherein the processor executes an automatic gain control (AGC) scheme to output the control voltage.

33. A method according to claim 31, wherein the power amplifier is powered by a battery.

34. An apparatus for use in a cellular handset, the apparatus comprising:
means for receiving a control voltage from a processor configured to predictively output the control voltage for continuous control; and
means for generating, in response to the control voltage, an output voltage to variably control a supply voltage of a power amplifier for minimizing current drain.

35. An apparatus according to claim 34, wherein the processor executes an automatic gain control (AGC) scheme to output the control voltage.

36. An apparatus according to claim 34, further comprising:
a battery supplying power to the power amplifier.
